(19) United States
(12) Patent Application Publication
(10) Pub. No.: US 2014/0093665 A1
(43) Pub. Date: Apr. 3, 2014

(54) DECORATIVE MEMBER FOR VEHICLE

(71) Applicant: TOYODA GOSEI CO., LTD., Kiyosu-shi (JP)

(72) Inventors: Hitoshi HORIBE, Kiyosu-shi (JP); Daiichiro KAWASHIMA, Kiyosu-shi (JP); Hideto MAEDA, Kiyosu-shi (JP)

(21) Appl. No.: 13/930,115

(22) Filed: Jun. 28, 2013

(30) Foreign Application Priority Data
Sep. 28, 2012 (JP) 2012-215676

(51) Int. Cl. B60R 13/04

(52) U.S. Cl. CPC B60R 13/04
USPC 428/31

(57) ABSTRACT

A decorative member for vehicle includes a transparent substrate, a decorative layer, and a resinous adhesion layer. The transparent substrate has a front face and a rear face, and includes a transparent material. The decorative layer is formed on the rear face of the transparent substrate, and is visible through the transparent substrate when the decorative member is viewed on the front face of the transparent substrate. The resinous adhesion layer covers the rear face of the transparent substrate on which the decorative layer is formed, and includes a hot-melt adhesive.

### INCORPORATION BY REFERENCE

The present invention is based on Japanese Patent Application No. 2012-215676, filed on Sep. 28, 2012, the entire contents of which are incorporated herein by reference.

### BACKGROUND OF THE INVENTION

1. Field of the Invention

The present invention relates to a decorative member for vehicle. For example, it relates to a vehicular decorative member being used for electromagnetic-wave transmission covers that are disposed in front of millimeter-electromagnetic-wave radar.

2. Description of the Related Art

Auto-cruising systems are an engineering technique for controlling inter-vehicular distance, or distance between two vehicles. An auto-cruising system comprises an onboard sensor that a vehicle has on the front side. The onboard sensor measures inter-vehicular distances between one's own vehicle (or a trailing vehicle) and a leading vehicle, or relative speeds of the trailing vehicle's speeds to the leading vehicle's speeds. Based on the resulting information, the auto-cruising system controls the throttle or brake of one's own vehicle in order to accelerate or decelerate one's own vehicle, thereby controlling the inter-vehicular distances. The auto-cruising systems have been attracting the auto industry's attention recently as one of core technologies for intelligent transportation system (or ITS) to be aimed at.

As an onboard sensor that is employed for auto-cruising system, laser radars, millimeter-electromagnetic-wave radars have been used commonly. A millimeter-electromagnetic-wave radar transmits a millimeter electromagnetic wave, and then receives the millimeter electromagnetic wave that has collided with and has reflected from an object. Thus, the millimeter-electromagnetic-wave radar measures inter-vehicular distances or relative speeds between a leading vehicle and a trailing vehicle (or one's own vehicle) based on differences between the resultant transmitted electromagnetic wave and received electromagnetic wave. For example, the transmitted millimeter electromagnetic wave exhibits a frequency of from 30 GHz to 300 GHz, and exhibits a wavelength of from 1 mm to 10 mm.

Note herein that an electromagnetic-wave transmission member has been heretofore disposed conventionally in front of a millimeter-electromagnetic-wave radar. A millimeter electromagnetic wave emitted from the millimeter-electromagnetic-wave radar transmits through an electromagnetic-wave transmission member, and is then output toward a vehicle's front. It is needed for the electromagnetic-wave transmission member to output the millimeter electromagnetic wave, which the millimeter-electromagnetic-wave radar outputs, to the outside with uniform output value and with minimized propagation loss. Consequently, it is required that the electromagnetic-wave transmission member be made to have a constant thickness as to the relationship with the millimeter electromagnetic wave's wavelength λ.

An electromagnetic-wave radar has been usually disposed onto a front grille's rear-face side. The front grille, however, interferes with the pass of electromagnetic-wave, because it does not have a constant thickness, or because it is made of metal, or it is provided with a metallic plating layer on the front face. Hence, Japanese Unexamined Patent Publication (KOKAI) Gazette No. 2010-66152 proposes the following engineering technique: opening a window in a part of front grille that corresponds to the front side of electromagnetic-wave radar for vehicle; and fitting an electromagnetic-wave transmission cover, which is made from resin, into the resulting window.

However, the conventional engineering technique that Japanese Unexamined Patent Publication (KOKAI) Gazette No. 2010-66152 discloses has resulted in limited decorative designs, because boundaries, which result from gaps between the electromagnetic-wave transmission cover and the front grille, have occurred between the two constituent elements.

As Japanese Unexamined Patent Publication (KOKAI) Gazette No. 2005-112193 discloses, it has been proposed recently to integrally mold both of a front grille and an electromagnetic-wave transmission member with a radar-transmissive material, such as acrylic resins, in order to improve qualities of the resulting front grille in the appearance.

However, since acrylic resins are low in the heat resistance, there is a fear that high temperatures and high pressures at the time of injection molding might possibly damage the resulting electromagnetic-wave transmission member. Moreover, when a printed decoration layer is buried in the resultant electromagnetic-wave transmission member, the printed decoration layer's decorative designs might possibly be damaged, so that the resulting front grille might show poor looks.

Moreover, ornaments to be attached to vehicle have been available, ornaments in which a transparent substrate is provided with a decorative layer on the rear face. Some of the ornaments may further comprise a base substrate, which is disposed on the ornaments' rear face and which is made from a resinous material so as to cover the decorative layer. When such ornaments' base substrate is also formed of an acrylic resin, the resulting base substrate might possibly be of low heat resistance. In addition, the decorative layer might also possibly suffer from damages, and thereby the resultant ornaments as well might also possibly become poor in the looks.

### SUMMARY OF THE INVENTION

The present invention has been developed in view of the above-described circumstances. It is therefore an object of the present invention to provide a decorative member for vehicle, decorative member whose looks are nice and which is less likely to be susceptible to damages that result from heat and/or pressure at the time of manufacture.

For example, a decorative member for vehicle according to the present invention comprises:

a transparent substrate having a front face and a rear face, and comprising a transparent material;

a decorative layer being formed on the rear face of the transparent substrate, and being visible through the transparent substrate when the decorative member is viewed on the front face of the transparent substrate; and

a resinous adhesion layer covering the rear face of the transparent substrate on which the decorative layer is formed, and comprising a hot-melt adhesive.

The decorative layer is covered with the resinous adhesion layer that comprises a hot-melt adhesive. The hot-melt adhesive is supplied onto the rear face of the transparent substrate in such a state that it is melted and is turned into one exhibiting a low viscosity. Consequently, it is possible to form the resinous adhesion layer under a relatively low pressure. Besides, the hot-melt adhesive is less likely to cause damages or deformations to occur in the decorative layer and transparent substrate, because it melts at a relatively low temperature. Hence, the resinous adhesion layer comprising a hot-melt adhesive hardly impairs the decorative layer in the looks at the time of manufacturing the decorative member for vehicle according to the present invention.

In the decorative member for vehicle according to the present invention, it is preferable that the transparent substrate, the decorative layer and the resinous adhesion layer can make an, electromagnetic-wave transmission subassembly being disposed in front of a millimeter-electromagnetic-wave radar; and the transparent substrate, the decorative layer and the resinous adhesion layer can have a thickness, respectively, and a summed thickness of the thicknesses of the transparent substrate, decorative layer and resinous adhesion layer can exhibit a predetermined thickness uniformly in the electromagnetic-wave transmission subassembly.

In the electromagnetic-wave transmission subassembly, a summed thickness of the thicknesses of the transparent substrate, decorative layer and resinous adhesion layer makes a predetermined thickness uniformly. That is, the electromagnetic-wave transmission subassembly exhibits an identical thickness over its own region as a whole. Consequently, it is possible for millimeter electromagnetic waves to uniformly transmit through the electromagnetic-wave transmission subassembly.

In the decorative member for vehicle according to the present invention, it is preferable that the electromagnetic-wave transmission subassembly can comprise: the transparent substrate exhibiting a relative dielectric constant; the resinous adhesion layer exhibiting another relative dielectric constant; and the relative dielectric constant of the transparent substrate approximating the relative dielectric constant of the resinous adhesion layer within a range of ±0.2. That is, let the transparent substrate's relative dielectric constant and the resinous adhesion layer's relative dielectric constant label as ∈ₜₛ/∈₀ and ∈ᵣₐₗ/∈₀, respectively, where ∈₀ is the dielectric constant of vacuum, an absolute value of the difference between ∈ₜₛ/∈₀ and ∈_{rds}/∈₀ can preferably be less than or equal to 0.2 (i.e., |∈ₜₛ/∈₀−∈_{rds}/∈₀|≦0.2).

The relative dielectric constant (or specific inductive capacity) of the resinous adhesion layer approximates the relative dielectric constant of the transparent substrate within the predetermined range, or the former is equal to the latter. Consequently, millimeter electromagnetic waves hardly attenuate or damp between the resinous adhesion layer and the transparent substrate.

In the decorative member for vehicle according to the present invention, it is preferable that the decorative layer, and the resinous adhesion layer can be formed partially on the rear face of the transparent substrate. If such is the case, it is possible to make a mold or die for forming the resinous adhesive layer smaller than another mold or die for molding the transparent substrate.

In the decorative member for vehicle according to the present invention, it is preferable that the rear face of the transparent substrate can be provided with an irregularity; and that the decorative layer can be formed on the irregularity. The decorative layer is formed on the irregularity in the rear face of the transparent substrate. Accordingly, when the present vehicular decorative member is viewed on the transparent substrate's front face, the decorative layer appears three-dimensionally on the inner or back side to the transparent substrate. Consequently, the present vehicular decorative member is higher in the decorativeness.

The decorative member for vehicle according to the present invention can preferably further comprise a base substrate covering a rear face of the resinous adhesive layer. If so, the base substrate reinforces the transparent substrate on the rear-face side. Note herein that the resinous adhesion layer's rear face faces to or is directed to the same side as the transparent substrate's rear face faces or is directed to.

In the decorative member for vehicle according to the present invention, it is preferable that the hot-melt adhesive can comprise at least one member that is selected from the group consisting of polyamides, polyurethanes, and polyesters. If so, it is possible to form the resinous adhesion layer by molding a hot-melt adhesive, which comprises at least one of these resinous materials, at low temperatures under low pressures.

The decorative member for vehicle according to the present invention comprises the resinous adhesion layer being made from a hot-melt adhesive that covers the decorative layer. It is possible to mold the hot-melt adhesive under the condition of low temperature and low pressure relatively. Therefore, it is possible to prevent the hot-melt adhesive from giving damages to the decorative layer and transparent substrate with which the hot-melt adhesive comes in contact at the time of manufacture.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a plan-view diagram for illustrating a front grille according to Embodiment No. 1 of the present invention.

FIG. 2 is an enlarged plan-view diagram for illustrating an electromagnetic-wave transmission subassembly in the present front grille according to Embodiment No. 1.

FIG. 3 is a cross-sectional diagram taken in the arrowheaded direction of “3”-“3” in FIG. 2.

FIG. 4 is an explanatory diagram for illustrating a relationship between the present front grille according to Embodiment No. 1, a mold or die for forming a resinous adhesion layer, and a retainer jig.

FIG. 5 is a cross-sectional diagram for illustrating a front grille according to Embodiment No. 2 of the present invention.

FIG. 6 is an enlarged cross-sectional diagram for illustrating a front grille according to Embodiment No. 3 of the present invention.

FIG. 7 is a cross-sectional diagram for illustrating a front grille according to Embodiment No. 4 of the present invention.

FIG. 8 is a cross-sectional diagram for illustrating a front grille according to Embodiment No. 5 of the present invention.

FIG. 9 is a cross-sectional diagram for illustrating a front grille according to Embodiment No. 6 of the present invention.

FIG. 10 is a plan-view diagram for illustrating an electromagnetic-wave transmission subassembly in a front grille according to Embodiment No. 7 of the present invention.

FIG. 11 is across-sectional diagram for illustrating the present front grille according to Embodiment. No. 7.

FIG. 12 is a cross-sectional diagram for illustrating a front grille according to Embodiment No. 8 of the present invention.

FIG. 13 is a cross-sectional diagram for illustrating a front grille according to Embodiment No. 9 of the present invention.

FIG. 14 is a plan-view diagram for illustrating an emblem according to Embodiment No. 10 of the present invention.

FIG. 15 is a cross-sectional diagram for illustrating the present emblem according to Embodiment No. 10.

FIG. 16 is a plan-view diagram for illustrating an emblem according to Embodiment No. 11 of the present invention.

FIG. 17 is a cross-sectional diagram for illustrating the present emblem according to Embodiment No. 11.

FIG. 18 is a plan-view diagram for illustrating an emblem according to Embodiment No. 12 of the present invention.

FIG. 19 is a cross-sectional diagram for illustrating the present emblem according to Embodiment No. 12.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

A decorative member for vehicle, which is directed to an embodiment mode according to the present invention, comprises a transparent substrate, a decorative layer, and a resinous adhesion layer.

The transparent substrate comprises a transparent resinous material. The term, “transparent,” involves not only when the transparent substrate is fully transparent but also when it is semi-transparent. The term also involves cases where the transparent substrate is transparent to such an extent that the decorative layer, which is formed on the transparent substrate's rear face, is visible clearly or blurredly when the present vehicular decorative member is viewed on the transparent substrate's front face. The transparent substrate can be colorlessly transparent as well as chromatically transparent.

As a transparent material for making the transparent substrate, it is possible, for example, to use one or more members that are selected from the group consisting of polycarbonate (or PC) resins and acrylic resins. The acrylic resins can be poly(acrylic acid) (or PAA) resins, poly(methacrylate) (or PMA) resins, and poly(methyl methacrylate) (or PMMA) resins, for instance. From the viewpoint of cost, an acrylic resin is a preferred option. From the viewpoint of moldability, a polycarbonate resin is a preferable option, because it is so soft that damages are less likely to occur in the resulting products at the time of demolding, namely, removing them from a mold or die.

The transparent substrate has a front face, and a rear face. The transparent substrate is a constituent element that is disposed on the front side of the present vehicular decorative member. Not only it is allowable that the transparent substrate's rear face can be a flat face, but also it is permissible that it can be provided with an irregularity. It is preferable that the transparent substrate can be provided with an irregularity in the rear face. When the transparent substrate's rear face is provided with an irregularity, it is more preferable that the decorative layer can be formed on parts of the rear face that involve the irregularity. The irregularity is provided with an irregular configuration that fits into the decorative layer's pattern or configuration in order to make the pattern or configuration appear three-dimensionally. It is advisable that the decorative layer can be formed on the irregularity's recessed sections or protruded sections alone, or can be formed on both of the recessed sections and protruded sections.

The decorative layer is formed on the transparent substrate's rear face, so that it is visible through the transparent substrate when the present vehicular decorative member is viewed on one of the opposite sides on the transparent substrate's front face. Not only it is allowable to form the decorative layer on the transparent substrate's rear face entirely, but also it is permissible to form the decorative layer on the rear face partially. Although it is also allowable to make up the decorative layer of a single layer alone, it is even permissible to make up the decorative layer of several layers. Moreover, although it is also allowable to give a single color to the decorative layer, it is even permissible to combine two or more colors in order to give colorful looks to the decorative layer.

As the decorative layer, it is possible to use the following: printed layers being formed by means of screen printing; metallic vapor-deposited films comprising metals, such as indium; transfer films being formed by means of process like hot stamping; for instance. Moreover, when the present vehicular decorative member is used as an electromagnetic-wave transmission cover, it is advisable that the decorative layer can be an electromagnetic-wave transmissive film that comprises an electromagnetic-wave transmissive paint. If such is the case, the transmission quantity of millimeter electromagnetic waves increases, because it is possible for millimeter electromagnetic waves to transmit through the decorative layer. As the electromagnetic-wave transmissive paint, it is possible to use those which have been known publicly, for instance. In general, as far as paints do not include any metal, they can be used as an electromagnetic-wave transmissive paint, respectively. Note however that, even among metals, indium can be used suitably for the decorative layer, because indium itself is likely to let millimeter electromagnetic waves transmit through it.

The resinous adhesion layer is formed on the transparent substrate's rear face so as to cover the decorative layer. It is advisable to form the resinous adhesion layer so as to cover the decorative layer at least. Not only it is allowable to form the resinous adhesion layer on the transparent substrate's rear face entirely, but also it is permissible to form it on the rear face partially. When the decorative layer is formed on parts of the transparent substrate's rear face, it is advisable to form the resinous adhesion layer on the parts of the rear face on which the decorative layer is formed. If so, it is possible to make a mold or die for forming the resinous adhesion layer smaller.

The resinous adhesion layer comprises a hot-melt adhesive. The term, “hot-melt adhesive,” refers to a 100%-solid-content adhesive in which a thermoplastic resin makes the major component, which does not contain any organic solvent at all, and which makes a solid or semisolid substance at ordinary or room temperature. A hot-melt adhesive belongs to a type of adhesives in which an adherent agent melts and then solidifies to demonstrate an adherent force. Note herein that no volatile substances, such as organic solvents, are present in the adherent agent. It is possible to make the resinous adhesion layer as follows: melting a hot-melt adhesive by heating, coating the molten hot-melt adhesive onto the transparent substrate's rear face, and then solidifying the coated molten hot-metal adhesive to bond it onto the rear face by cooling, for instance.

It is preferable that the hot-melt adhesive can comprise a resinous material whose moldable temperature is 200° C. or less. When the moldable temperature is more than 200° C., there might arise fears of damaging the decorative layer and transparent substrate, because the decorative layer and transparent substrate might possibly be exposed to undue high temperatures.

Moreover, it is preferable that the hot-melt adhesive can exhibit a softening temperature of 200° C. or less. In addition, it is more preferable that the softening temperature can fall in a range of from 150 to 180° C. When the hot-melt adhesive exhibits an excessively high softening temperature, the decorative layer and transparent substrate might possibly be exposed to undue high temperatures at the time of making the resinous adhesion layer. As a result, such fears might arise that the decorative layer and transparent substrate are damaged.

As such a hot-melt adhesive, it is possible to name the following: “QR9515” produced by YOKOHAMA RUBBER Co., Ltd., “MN-70” produced by YOKOHAMA RUBBER Co., Ltd., and “OM652” produced by HENKEL JAPAN Co., Ltd., for instance.

A base substrate can further cover the resinous adhesion layer's rear face. The base substrate enhances the present vehicular decorative member in terms of strength. The base substrate can either be subjected to coloring or cannot be subjected to coloring. In order to make the base substrate, it is possible to use a resinous material, such as acrylonitrile-ethylene-styrene (or AES) copolymers or acrylonitrile-butadiene-styrene (or ABS) copolymerized resins, for instance. Among these resinous materials, an AES copolymer is preferred, because AES copolymers exhibit a coefficient of contraction as well as a relative dielectric constant that are close to those of polycarbonate resins, respectively.

When a decorative member for vehicle according to the present embodiment mode further comprises abase substrate, the resinous adhesion layer can be provided with an undercut that is complementary to or mold-symmetrical to the base substrate's front face. If such is the case, an enhanced bonding force is exerted between the resinous adhesion layer and the base substrate. The term, “rear face,” refers to one of the opposite faces of the decorative layer, resinous adhesion layer and base substrate that faces to the same side as the transparent substrate's rear face faces to. Moreover, the term, “front face,” refers to another one of the opposite faces of the decorative layer, resinous adhesion layer and base substrate that faces to the same side as the transparent substrate's front face faces to.

It is also advisable to form a base substrate on the rear-face side of the transparent substrate by means of subjecting a resinous material to insert molding. The resinous adhesion layer is heated and pressurized by a resinous material that melts at the time of insert molding. However, the resinous adhesion layer is of high heat resistance and pressure resistance. Accordingly, the resinous adhesion layer relieves adverse effects resulting from heat and pressure that have influences on the decorative layer and transparent substrate. Consequently, the resinous adhesion layer makes the fear of damaging the decorative layer and transparent substrate by heat and pressure less likely to arise.

Moreover, it is also allowable to form a base substrate as another constituent element, which is separate from the transparent substrate, and thereafter bond it onto the transparent substrate's rear face with the resinous adhesion layer. When a base substrate is a separate constituent element that is independent of the transparent substrate, and when the base substrate is bonded onto the transparent substrate by the resinous adhesion layer, only a hot-melt adhesive, which has been softened and/or melted at the time of bonding, heats and pressurizes the decorative layer and transparent substrate. The heating temperature and pressure resulting from the hot-melt adhesive are so low relatively that they are less likely to damage the decorative layer and transparent substrate. When an independent constituent element makes the base substrate, it is permissible to seal the outer rim by welding with use of laser, and so on, in order to prevent moistures from infiltrating.

The present vehicular decorative member can preferably comprise an electromagnetic-wave transmission subassembly to be disposed in front of a millimeter-electromagnetic-wave radar. The electromagnetic-wave transmission subassembly comprises the transparent substrate, the decorative layer, and the resinous adhesion layer. It is required for the electromagnetic-wave transmission subassembly to transmit millimeter electromagnetic waves through it when it is irradiated with the millimeter electromagnetic waves. In order to let millimeter electromagnetic waves transmit, it is required that at least the transparent substrate exhibit millimeter-electromagnetic-wave transmissivity. When the decorative layer is formed on some of parts alone in the electromagnetic-wave transmission subassembly, the decorative layer is not necessarily required to exhibit millimeter-electromagnetic-wave transmissivity.

The electromagnetic-wave transmission subassembly can preferably have a predetermined thickness in order to keep down the attenuation or damp quantity of millimeter electromagnetic waves when they transmit through the electromagnetic-wave transmission subassembly. That is, since the electromagnetic-wave transmission subassembly comprises the transparent substrate, the decorative layer and the resinous adhesion layer, it is allowable to set up an overall thickness of these constituent elements at a predetermined thickness. For example, in order for a millimeter electromagnetic wave to be output from the electromagnetic-wave transmission subassembly without being attenuated or damped, it is permissible that an entire thickness of the electromagnetic-wave transmission subassembly can be an integral multiple of a half of the millimeter electromagnetic wave's wavelength λ when the millimeter electromagnetic wave transmits through the electromagnetic-wave transmission subassembly.

In the electromagnetic-wave transmission subassembly, it is preferable that the transparent substrate's relative dielectric constant can approximate the resinous adhesion layer's relative dielectric constant within a range of ±0.2. Moreover, it is more preferable that the former can approximate the latter within a range of ±0.1. Thus, without causing millimeter electromagnetic waves to attenuate or damp at the interface between the transparent substrate and the resinous adhesion layer, it is possible to transmit the millimeter electromagnetic waves through the electromagnetic-wave transmission subassembly. On the contrary, when the difference between the relative dielectric constants goes beyond the range of ±0.2, there might possibly arise a fear of making the attenuation or damp quantity of millimeter electromagnetic waves greater between the transparent substrate and the resinous adhesion layer.

Let us consider the transparent substrate and resinous adhesion layer in the electromagnetic-wave transmission subassembly as a dielectric substance, vibrations of the molecules in the dielectric substance result in electric energy loss when the dielectric substance is irradiated with millimeter electromagnetic waves. An extent of the electric energy loss is referred to as a “dielectric loss tangent.” When the transparent substrate's relative dielectric constant and the resinous adhesion layer's dielectric constant approximate one another, the transparent substrate's dielectric loss tangent and the resinous adhesion layer's dielectric loss tangent also approximate one another.

In the electromagnetic-wave transmission subassembly, it is preferable that the transparent substrate can exhibit a relative dielectric constant falling in a range of from 2.5 to 2.9. In order for making the transparent substrate exhibiting such a relative dielectric constant, it is possible to name polycarbonate (or PC) resins, and acrylic resins. The acrylic resins can be poly (acrylic acid) (or PAA) resins, poly (methacrylate) (or PMA) resins, and poly (methyl methacrylate) (or PMMA) resins, for instance. Table 1 below gives the relative dielectric constant, dielectric loss tangent and molding temperature of respective materials that can be used for making the transparent substrate.

Likewise, in the electromagnetic-wave transmission subassembly, it is preferable that the resinous adhesion layer can exhibit a relative dielectric constant falling in a range of from 2.5 to 2.9. In order for making the resinous adhesion layer exhibiting such a relative dielectric constant, it is possible to name polyamide (or PA) resins, polyurethane (or PU) resins, and polyester (or PE) resins, for instance. Table 1 below gives the relative dielectric constant, dielectric loss tangent and molding temperature of several resins being included in a hot-melt adhesive that can be used for making the resinous adhesion layer.

Moreover, when the electromagnetic-wave transmission subassembly comprises the resinous adhesion layer that is provided with a base substrate on the rear face, it is advisable that the resinous adhesion layer's relative dielectric constant and the base substrate's relative dielectric constant can approximate one another. For example, it is preferable that the resinous adhesion layer's relative dielectric constant can approximate the base layer's relative dielectric constant within a range of ±0.2. That is, let the resinous adhesion layer's relative dielectric constant and the base substrate's relative dielectric constant label as ∈ᵣₐₗ/∈₀ and ∈_{bs}/∈₀/respectively, where ∈₀ is the dielectric constant of vacuum, an absolute value of the difference between ∈ᵣₐₗ/∈₀ and ∈_{bs}/∈₀ can preferably be less than or equal to 0.2 (i.e., |∈ᵣₐₗ/∈₀−∈_{bs}/∈₀|≦0.2). The former and the later are thus set up in order to prevent millimeter electromagnetic waves from attenuating or damping at the interface between the resinous adhesion layer and the base substrate. Note that the resinous adhesion layer's relative dielectric constant can differ from the base substrate's relative dielectric constant. If so, such a fear might possibly arise that millimeter electromagnetic waves attenuate or damp at the interface between the resinous adhesion layer and the base substrate.

In the electromagnetic-wave transmission subassembly that further comprises a base substrate, it is preferable that the base substrate can exhibit a relative dielectric constant falling in a range of from 2.5 to 2.9. As a material that can be used for making such a base substrate in the electromagnetic-wave transmission subassembly, it is possible to name acrylonitrile-ethylene-styrene (or AES) copolymers, for instance. Table 1 below gives the relative dielectric constant, dielectric loss tangent and molding temperature of an AES copolymer that can be used for making the base substrate.

TABLE 1

| | | Relative | Dielectric | Molding |
|---|---|---|---|---|
| | | Dielectric | Loss | Temperature |
| | Material | Constant | Tangent | (° C.) |
| Transparent | PC | 2.7 | 0.018 | 270-320 |
| Substrate | Acrylic Resin | 2.6 | 0.008 | 210-260 |
| Resinous | Polyamide | 2.5 | 0.027 | 180-200 |
| Adhesion | Polyurethane | 2.7 | 0.016 | 180-200 |
| Layer | Polyester | 2.7 | 0.025 | 175-200 |
| Base Substrate | AES | 2.7 | 0.011 | 200-260 |

Note that the characteristics of the various materials being given in Table 1 might possibly depend on components in the materials, production processes for them, and so on, even when they are classified into an identical class of materials. For example, even among the polyamide resins, such a certain type of polyamide resins exist as they exhibit a relative dielectric constant of 4.4 and a dielectric loss tangent of 0.248.

Hereinafter, some of preferable combinations of the materials, which exhibit the characteristics that are listed in Table 1 above, will be hereinafter described as examples for making each of the transparent substrate and resinous adhesion layer in the electromagnetic-wave transmission subassembly.

(a) an acrylic resin making the transparent substrate, and a hot-melt adhesive comprising a polyamide resin that makes the resinous adhesive layer; (b) an acrylic resin making the transparent substrate, and a hot-melt adhesive comprising a polyurethane resin that makes the resinous adhesive layer; and (c) an acrylic resin making the transparent substrate, and a hot-melt adhesive comprising a polyester resin that makes the resinous adhesive layer

Moreover, when the electromagnetic-wave transmission subassembly further comprises a base substrate that is formed on the rear face of the resinous adhesion layer, it is preferable to use the following combinations of the materials for making each of the resinous adhesion layer and base substrate in the electromagnetic-wave transmission subassembly in order to inhibit millimeter electromagnetic waves from attenuating or damping.

(d) a hot-melt adhesive comprising a polyamide resin that makes the resinous adhesive layer, and an AES copolymer making the base substrate; (e) a hot-melt adhesive comprising a polyurethane resin that makes the resinous adhesive layer, and an AES copolymer making the base substrate; and (f) a hot-melt adhesive comprising a polyester resin that makes the resinous adhesive layer, and an AES copolymer making the base substrate

The decorative layer is formed in the electromagnetic-wave transmission subassembly entirely or partially. The decorative layer can preferably exhibit millimeter-electromagnetic-wave transmissivity. As a result, the electromagnetic-wave transmission subassembly comes to exhibit millimeter-electromagnetic-wave transmissivity as a whole. The decorative layer exhibiting millimeter-electromagnetic-wave transmissivity can preferably have such a thin thickness as from 0.05 to 0.1 mm. Moreover, the decorative layer cannot contain any metallic components that are of low millimeter-electromagnetic-wave transmissivity. Note however that, among metallic components, indium is suitable for making the decorative layer, because indium itself is likely to transmit millimeter electromagnetic waves.

When the decorative layer does not exhibit any millimeter-electromagnetic-wave transmissivity, it is advisable to form the decorative layer in the electromagnetic-wave transmission subassembly partially. In this instance, millimeter electromagnetic waves transmit through parts of the electromagnetic-wave transmission subassembly in which the decorative layer is not formed.

The present vehicular decorative member comprising the electromagnetic-wave transmission subassembly is disposed in front of a millimeter-electromagnetic-wave radar. It is also allowable to dispose the present vehicular decorative member so that the electromagnetic-wave transmission subassembly separates from a millimeter-electromagnetic-wave radar on the rear-face side, or it is even permissible to integrally assemble the electromagnetic-wave transmission subassembly with a millimeter-electromagnetic-wave radar on the rear-face side. In the case where the electromagnetic-wave transmission subassembly is assembled integrally with a millimeter-electromagnetic-wave radar, the diffusion width of millimeter electromagnetic waves becomes narrower when the millimeter electromagnetic waves reach the electromagnetic-wave transmission subassembly. This makes it possible to make the electromagnetic-wave transmission subassembly smaller, and accordingly leads to downsizing the present vehicular decorative member.

For example, the present vehicular decorative member is applicable to front grilles, back panels, emblems, and the like. In particular, the present vehicular decorative member comprising the electromagnetic-wave transmission subassembly is applicable to front grilles, for instance; whereas the present vehicular decorative member free from the electromagnetic-wave transmission subassembly is applicable to side moldings, for instance.

### EMBODIMENTS

### Embodiment No. 1

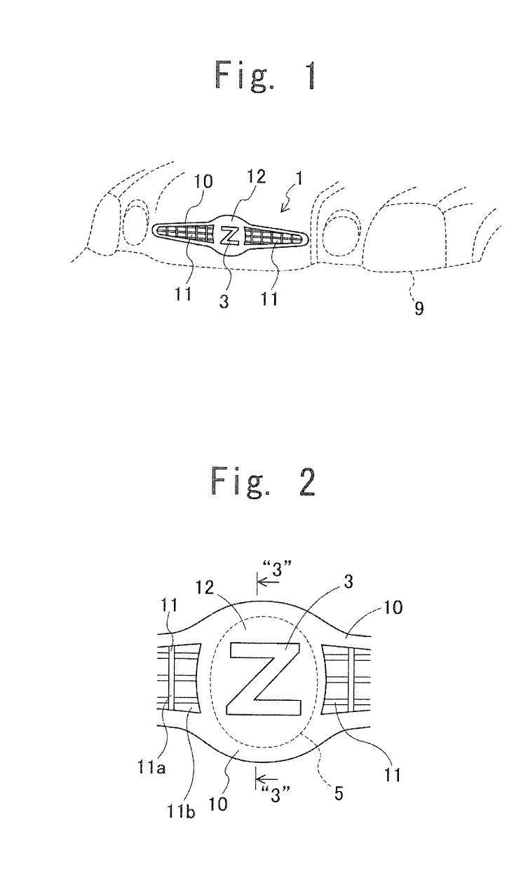

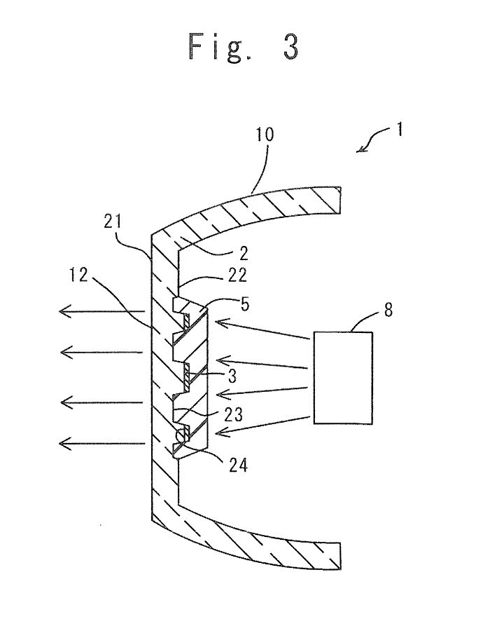

A decorative member for vehicle according to Embodiment No. 1 of the present invention will be hereinafter described with reference to FIGS. 1 through 4. The present vehicular decorative member according to Embodiment No. 1 makes a front grille. FIG. 1 shows a front grille 1 according to Embodiment No. 1 as a whole in a plan-view diagram. FIG. 2 is an enlarged plan-view diagram of an electromagnetic-wave transmission subassembly 12 in the front grille 1. FIG. 3 shows the front grille 1 in a cross-sectional diagram.

As illustrated in FIG. 1, the front grille 1 comprises a framed part 10, grilled parts (11, 11) and an electromagnetic-wave transmission subassembly 12. The framed part 10 has a flat configuration that extends long in the right/left direction. The grilled parts (11, 11) are formed in the framed part 10, and are disposed on the right and left opposite sides inside the framed part 10, respectively. The electromagnetic-wave transmission subassembly 12 is disposed at the central section inside the framed part 10. As illustrated in FIGS. 1 through 3, the framed part 10 takes on a configuration that curves toward the rear face in order to fasten the front grille 1 onto a vehicular body 9. The grilled parts (11, 11) are provided with grates 11a that extend in the up/down direction and right/left direction. The grilled parts (11, 11) introduce air in front of the vehicular body 9 into the interior of the vehicular body 9 through openings 11b that are formed between the respective grates 11a, thereby air cooling a not-shown engine behind the front grille 1.

As illustrated in FIG. 3, a millimeter-electromagnetic-wave radar 8 is disposed behind the front grille 1. The millimeter-electromagnetic-wave transmission subassembly 12 is a portion to be irradiated with a millimeter electromagnet ic wave that the millimeter-electromagnetic-wave radar 8 outputs. The millimeter-electromagnetic radar 8 is put in a position that separates by a slight interval from the electromagnetic-wave transmission subassembly 12 of the front grille 1. The millimeter electromagnetic wave, which the millimeter-electromagnetic-wave radar 8 produces, exhibits a frequency of 76.5 GHz. The front grille 1 is made of a transparent substrate 2. As illustrated FIGS. 2 and 3, the framed part 10 and grilled parts (11, 11) are made up of a single layer alone that is formed of the transparent substrate 2. The electromagnetic-wave transmission subassembly 12 comprises the transparent substrate 2, a decorative layer 3, and a resinous adhesion layer 5. The decorative layer 3, and the resinous adhesion layer 5 are laminated one after another on a rear face 22 of the transparent substrate 2.

The transparent substrate 2 is made from an acrylic resinous material. The transparent substrate 2 is a constituent element that makes the front grille 1 as a whole. In the electromagnetic-wave transmission subassembly 12, a front face 21 of the transparent substrate 2 takes on a flat smoothed surface, whereas the rear face 22 of the transparent substrate 2 is provided with an irregularity 23 that is shaped into a letter. The irregularity 23 is formed so as to make the lettered part thicker protuberantly. Note that, in the electromagnetic-wave transmission subassembly 12, the transparent substrate 2 has a thickness that falls in a range of from 3 to 5.3 mm, because it is provided with the irregularity 23.

The decorative layer 3 is made from a metallic foil that has been transferred by hot stamping. The decorative layer 3 is formed onto protuberances 24 that shape the lettered part in the irregularity 23 of the transparent substrate 2. The decorative layer 3 has such a thin thickness as from 0.05 to 0.1 mm. The unevenness in the irregularity 23 is 2.3 mm. The transparent substrate 2, and the resinous adhesion layer are transparent. When the electromagnetic-wave transmission subassembly 12 is viewed from one of the opposite sides on the front face 21 of the transparent substrate 2, a metallic taste letter comprising the decorative layer 3 is visible inside the transparent background.

The resinous adhesion layer 5 is made from a hot-melt adhesive. A material for making the hot-melt adhesive comprises polyamide, polyurethane, or polyester. The resinous adhesion layer 5 is formed on the rear face 22 of the transparent substrate 2 so as to cover the decorative layer 3. The resinous adhesion layer 5 has a thickness that falls either in a range of from 0.7 to 3.0 mm, or in another range of from 1.9 to 4.2 mm. Thus, the electromagnetic-wave transmission subassembly 12 has an overall thickness of either 6.0 mm or 7.2 mm in which the thicknesses of the transparent substrate 2, decorative layer 3 and resinous adhesion layer 5 are summed up. The overall thickness makes an integral multiple of the half wavelength of the millimeter electromagnetic wave that the millimeter-electromagnetic-wave radar 8 outputs, and accordingly is a thickness that makes it possible to transmit the millimeter electromagnetic wave through the electromagnetic-wave transmission subassembly 12 without attenuating or damping the millimeter electromagnetic wave. The transparent substrate 2 exhibits a relative dielectric constant of 2.6, and the resinous adhesion layer 5 exhibits a relative dielectric constant of 2.7. Consequently, both of the relative dielectric constants coincide with each other substantially.

In order to manufacture the present front grille according to Embodiment No. 1, the transparent substrate 2 is first of all made by injection molding using a mold. After taking out the resulting transparent substrate 2 from the mold, a metallic foil is heat transferred onto the protuberances 24 in the irregularity 23 in the rear face 22 of the transparent substrate 2 using a hot stamping machine. Thus, the decorative layer 3 is formed.

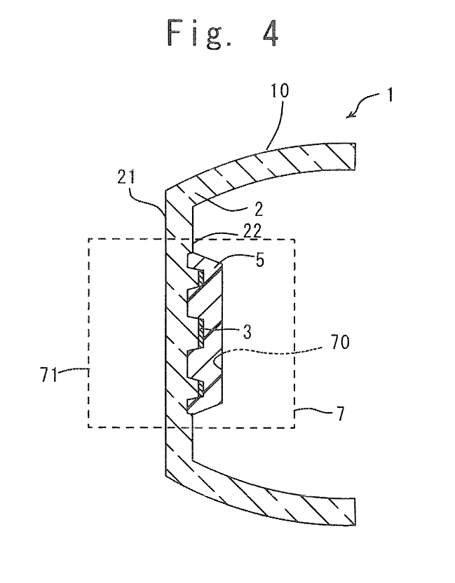

FIG. 4 is an explanatory diagram that shows a positional relationship between the front grille 1 and a mold 7 as well as a retainer jig 71 that are used for molding the resinous adhesion layer 5. As illustrated in the drawing, the mold 7 is disposed on the rear-face side of the transparent substrate 2 with the completed decorative layer 3, whereas the retainer jig 71 is disposed on the front-face side of the transparent substrate 2. Then, a hot-melt adhesive is heated to 200° C. in order to soften or melt it. The resultant softened or molten hot-melt adhesive is injected into a cavity 70 in the mold 7, thereby forming the resinous adhesive layer 5. Note herein that the mold 7 for molding the resinous adhesion layer 5 can also be made smaller, because the front grille 1 is provided with the electromagnetic-wave transmission subassembly 12 at the central section alone as can be seen from FIG. 4 (or FIG. 1).

The present front grille 1 according to Embodiment No. 1 comprises the resinous adhesion layer 5 being made from a hot-melt adhesive that covers the decorative layer 3. As can be understood from FIG. 4, the hot-melt adhesive is supplied onto the rear face 22 of the transparent substrate 2 under such a condition that it is melted to exhibit a lowered viscosity. Accordingly, it is possible to form the resinous adhesion layer 5 at a relatively low pressure. Besides, the hot-melt adhesive is less likely to cause damages or deformations to occur in the transparent substrate 2 and decorative layer 3, because it melts at a relatively low temperature. Consequently, the hot-melt adhesive is less likely to impair the decorative layer 3 in the looks at the time of manufacturing the front grille 1.

In the electromagnetic-wave transmission subassembly 12, the summed thickness of the thicknesses of the transparent substrate 2, decorative layer 3 and resinous adhesion layer 5 is set to a predetermined thickness uniformly. Accordingly, the millimeter electromagnetic wave transmits through the electromagnetic-wave transmission subassembly 12 uniformly. Moreover, the relative dielectric constant of the resinous adhesion layer 5 coincides with the relative dielectric constant of the transparent substrate 2 virtually within a predetermined range. Consequently, the millimeter electromagnetic wave hardly attenuates or damps between the resinous adhesion layer 5 and the transparent substrate 2.

The decorative layer 3 is formed on the protuberances 24 in the irregularity 23 in the rear face 22 of the transparent substrate 2. As a result, the decorative lay 3 appears three-dimensionally on the inner or back side to the transparent substrate 2 when the front grille 1 according to Embodiment No. 1 is viewed from one of the opposite sides on the front face 21 of the transparent substrate 2. Therefore, the present front grille 1 according to Embodiment No. 1 is of high decorativeness.

### Embodiment No. 2

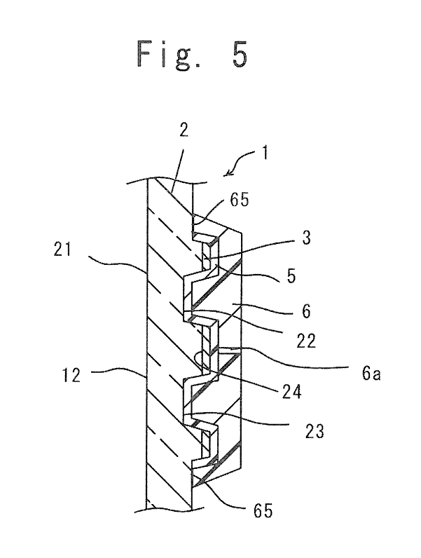

A front grille 1 according to Embodiment No. 2 of the present invention further comprises a base substrate 6 that is formed on a rear face of a resinous adhesion layer 5, as shown in FIG. 5. The base substrate 6 makes another molded body that is independent of a transparent substrate 2. The base substrate 6 is also transparent, and is made from an AES copolymer.

In the present front grille 1 according to Embodiment No. 2, an electromagnetic-wave transmission subassembly 12 has a laminated structure in which a decorative layer 3, the resinous adhesion layer 5 and the base substrate 6 are laminated one of ter another on a rear face 22 of the transparent substrate 2. The transparent substrate 2 is provided with an irregularity 23 in the rear face 22. The irregularity 23 is provided with the decorative layer 3 on the protuberances 24. The decorative layer 3, and the resinous adhesion layer intervene between the transparent substrate 2 and the base substrate 6. The base substrate 6 takes on an irregular configuration on the front face. Note that the irregular configuration is reflectional or mold-symmetrical to the irregularity 23 with which the transparent substrate 2 is provided in the rear face 22. On the contrary, the base substrate 6 takes on a flat smoothed face on the rear face. When a user views the electromagnetic-wave transmission subassembly 12 from one of the opposite sides on the front face, he or she can see a metallic taste letter comprising the decorative layer 3 inside the transparent background.

The transparent substrate 2 is made from an acrylic resin. The decorative layer 3 is made from a printed layer, or a foil. The resinous adhesion layer 5 is made from the same hot-melt adhesive as used in Embodiment No. 1. Moreover, the transparent substrate 2 has a thickness of from 3 to 5.3 mm. The decorative layer 3 has a thickness of 10 μm. The resinous adhesion layer 5 has a thickness of from 0.5 to 1.0 mm. The base substrate 6 has a thickness of from 0.9 to 3.7 mm. Note that, in the electromagnetic-wave transmission subassembly 12, a summed thickness of the thicknesses of the transparent substrate 2, decorative layer 3, resinous adhesion layer 5 and base substrate 6 is set at 7.2 mm. That is, the electromagnetic-wave transmission subassembly 12 exhibits the summed thickness as a whole. The summed thickness is an integral multiple of the half wavelength of a millimeter electromagnetic wave whose frequency is 76.5 GHz.

In order to manufacture the present front grille 1 according to Embodiment No. 2, a foil is first of all transferred onto the protuberances 24 in the irregularity 23 in the rear face 22 of the transparent substrate 2 to form the decorative layer 3 by hot stamping in the same manner as Embodiment No. 1. Alternatively, the decorative layer 3 can be formed by printing. On the other hand, the base substrate 6 is made by injection molding with an AES copolymer independently of the transparent substrate 2. Then, the resulting base substrate 6 is laminated onto the irregularity 23 of the transparent substrate 2 that is provided with the decorative layer 3 on the rear face 22. Moreover, the hot-melt adhesive, which have been melted, is injected into the clearance between the transparent substrate 2 and the base substrate 6 through injection inlets 6a with which the base substrate 6 is provided at several locations. Finally, the injected molten hot-melt adhesive is cooled to form the resinous adhesion layer 5 between the transparent substrate 2 and the base substrate 6. In addition, it is also possible to make a welded section 65 by welding the base substrate 6 with a laser onto the transparent substrate 2 at the outer circumference. Moreover, it is also advisable not to turn the base substrate 6 into the welded section 65 at the outer circumference.

The present front grille 1 according to Example No. 2 comprises the base substrate 6 that is formed on the rear-face side of the transparent substrate 2. Accordingly, the base substrate 6 reinforces the rear face of the resinous adhesion layer 5, so that the electromagnetic-wave transmission subassembly 12 exhibits an enhanced strength. Since the base substrate 6 is formed in the electromagnetic-wave transmission subassembly 12 of the present front grille 1 alone, the base substrate 6 is a smaller molded body than is the transparent substrate 2 making the present front grille 1 as a whole substantially. Consequently, it is possible to make a mold for molding the base substrate 6 smaller. Therefore, the resultant smaller mold leads to downsizing facilities for manufacturing the present front grille 1.

The AES copolymer making the base substrate 6 exhibits a relative dielectric constant of 2.7 that coincides with the relative dielectric constant of the resinous adhesion layer 5 virtually. Moreover, the relative dielectric constant of the resinous adhesion layer 5 coincides with the relative dielectric constant of the transparent substrate 2 virtually. As a result, it is possible for the present front grille 1 according to Example No. 2 to effectively inhibit the millimeter electromagnetic wave, which transmits through the electromagnetic-wave transmission subassembly 12, from attenuating or damping.

### Embodiment No. 3

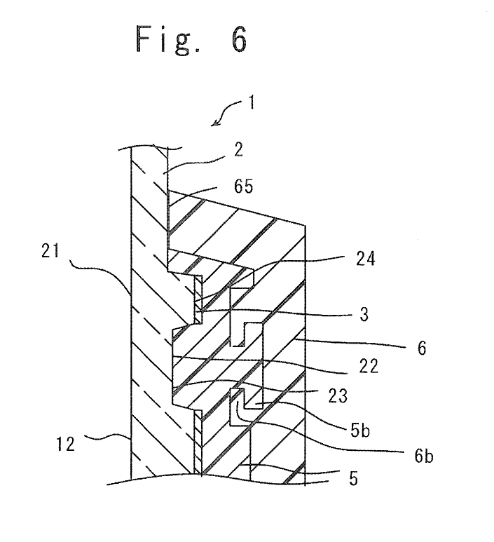

As illustrated in FIG. 6, a front grille 1 according to Embodiment No. 3 of the present invention comprises a transparent substrate 2 whose rear face 22 is provided with an irregularity 23. Moreover, the irregularity 23 is provided with a decorative layer 3 that shapes a letter. Onto the rear face 22 of the transparent substrate 2 on which the decorative layer 3 is formed, a base substrate 6 is formed by way of a resinous adhesion layer 5. Note that the transparent substrate 2 can have a flat face on the rear face 22.

The base substrate 6 is a molded body being made from an AES copolymer in the same manner as Embodiment No. 2. The base substrate 6 has an engaging section 6b, which is made thinner partially in the thickness-wise direction to form an undercut, on the front face. Likewise, the resinous adhesion layer 5 has an engaged section 5b, which makes another undercut that is complementary to or mold-symmetric to the engaging section 6b of the base substrate 6, on the rear face. Not only the engaging section 6b of the base substrate 6 and the engaged section 5b of the resinous adhesion layer 5 engage with each other, but also they adhere to each other firmly.

When manufacturing the present front grille 1 according to Embodiment No. 3, the base substrate 6, which has been molded in advance, is disposed on the irregularity 23 in the transparent substrate 2 that is provided with the decorative layer 3, in the same manner as Example No. 2. Then, the molten hot-melt adhesive is injected through not-shown injection inlets, with which the base substrate 6 is provided, in order to fill up the clearance between the transparent substrate 2 and the base substrate 6 with the molten hot-melt adhesive. Thus, the resinous adhesive layer 5 being made from the hot-melt adhesive is formed between the transparent substrate 2 and the base substrate 6. Thereafter, the base substrate 6 is welded at the outer-circumference rim to make a welded section 65 by a laser.

The present front grille 1 according to Embodiment No. 3 comprises the base substrate 6 whose front face is provided with the engaging section 6b that is formed as an undercut, and the resinous adhesion layer 5 whose rear face is provided with the engaged section 5b that is formed as another undercut. Therefore, the base substrate 6 firmly adheres to the resinous adhesion layer 5 in the present front grille 1.

### Embodiment No. 4

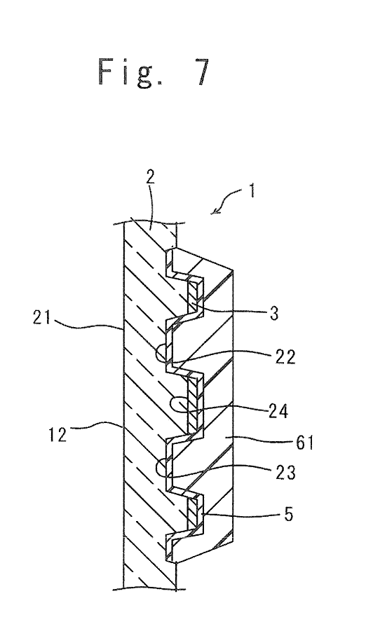

As illustrated in FIG. 7, a front grille 1 according to Embodiment No. 4 of the present invention comprises a base substrate 61 that is formed onto a rear face of a resinous adhesion layer 5 by insert molding. Note that the base substrate 61 is made from an AES copolymer.

In order to manufacture the present front grille 1 according to Embodiment No. 4, the manufacturing procedure as described in Embodiment No. 1 is followed to form the decorative layer 3, and the resinous adhesion layer 5 onto the rear face 22 of the transparent substrate 2. Subsequently, the transparent substrate 2 with the completed decorative layer 3 and resinous adhesion layer 5 is put in place on a mold for forming the base substrate 61. Then, an AES copolymer is injected into a cavity in the mold to mold the base substrate 61. Note that the AES copolymer exhibits such a high temperature as from 200 to 260° C. at the time of molding the base substrate 61. However, even when the high-temperature molten AES copolymer comes in contact with the resinous adhesion layer 5, the resinous adhesion layer 5 is little impaired, because it is made from the hot-melt adhesive exhibiting high heat resistance. As a result, even the decorative layer 3 and transparent substrate 2, which are put in place in front of the resinous adhesion layer 5, are hardly damaged at all by the molten AES copolymer. Other than the operation and advantage as described herein, the present front grille 1 according to Embodiment No. 4 operates and effects advantages in the same manner as Embodiment No. 1.

### Embodiment No. 5

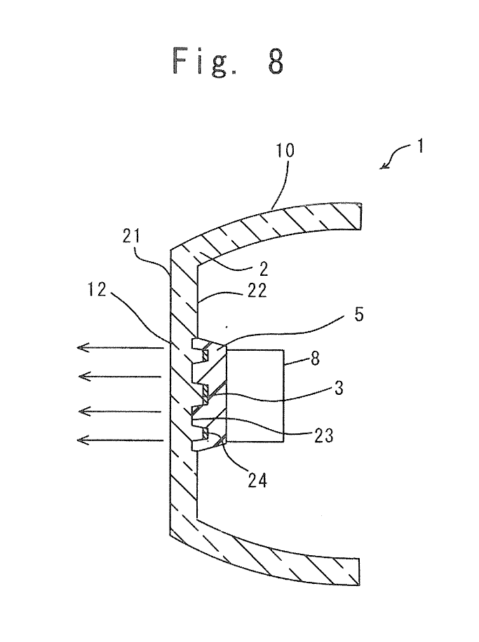

As illustrated in FIG. 8, a front grille 1 according to Embodiment No. 5 further comprises a millimeter-electromagnetic-wave radar 8 that is fixed on a rear face of a resinous adhesion layer 5. In order for fastening the millimeter-electromagnetic-wave radar 8 onto the resinous adhesion layer 5, a not-shown protuberant section, which protrudes from the resinous adhesion layer 5, is locked into a not-shown recessed section, with which a case for the millimeter-electromagnetic-wave radar 8 is provided. Scarcely any gap is present between the millimeter-electromagnetic-wave radar 8 and the resinous adhesion layer 5. Consequently, a millimeter electromagnetic wave, which an emitter of the millimeter-electromagnetic-wave radar 8 has emitted, enters the electromagnetic-wave transmission assembly 12 directly as an outgoing incident electromagnetic wave without being interrupted by any intervening space in which air exists. Moreover, the millimeter electromagnetic wave, which has been reflected by an object, enters a receiver of the millimeter-electromagnetic-wave radar 8 as an incoming incident electromagnetic wave through the electromagnetic-wave transmission subassembly 12 from the front face to the rear face. Accordingly, it is possible to decrease the number of attenuations or damps in the millimeter electromagnetic wave. Consequently, it is possible to make the millimeter electromagnetic wave enter the receiver of the millimeter-electromagnetic-wave radar 8 as an incoming incident electromagnetic wave without ever attenuating or damping the millimeter electromagnetic wave.

Moreover, since the millimeter electromagnetic wave, which the millimeter-electromagnetic-wave radar 8 has emitted, propagates radially, the irradiation range widens toward the front. When an interval, which separates the millimeter-electromagnetic-wave radar 8 from the electromagnetic-wave transmission subassembly 12, is present between them as that is present in Embodiment No. 1, it is necessary to make the electromagnetic-wave transmission subassembly 12 over a range that is wider than the irradiation range, which the millimeter-electromagnetic-wave radar 8 produces at the emitter (see FIG. 1), in order to input the emitted millimeter electromagnetic wave exactly into the electromagnetic-wave transmission subassembly 12.

The present front grille 1 according to Embodiment No. 5, however, comprises the resinous adhesion layer 5 making the rear face of the electromagnetic-wave transmission subassembly 12 on which the millimeter-electromagnetic-wave radar 8 is fixed directly. As a result, the millimeter electromagnetic wave, which the millimeter-electromagnetic-wave radar 8 has emitted, can be input into the electromagnetic-wave transmission subassembly 12 exactly without ever widening the irradiation range. Therefore, it is possible to intend to downsize the present front grille 1 according to Embodiment No. 5, because it is possible to make an area of the electromagnetic-transmission subassembly 12 smaller that is irradiated with the emitted millimeter electromagnetic wave. The present front grille 1 according to Embodiment No. 5 operates and effect advantages in the same manner as described in Embodiment No. 1, because it comprises the same constituent elements as those of Embodiment No. 1 except for the resinous adhesion layer 5 and millimeter-electromagnetic-wave radar 8 being elaborated herein.

### Embodiment No. 6

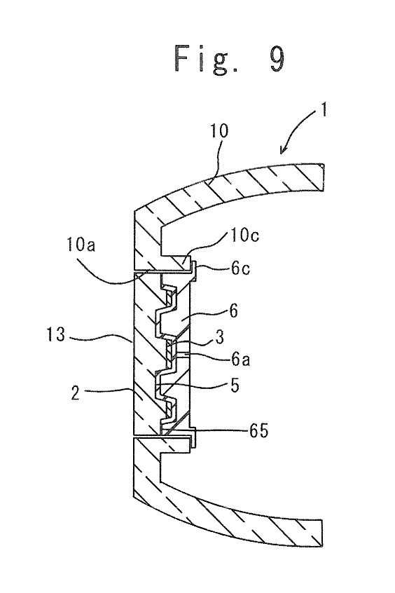

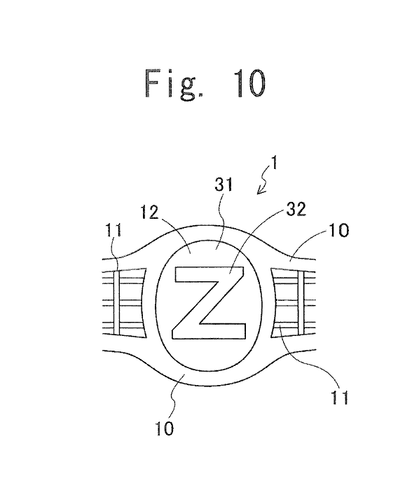

As illustrated in FIG. 9, a front grille 1 according to Embodiment No. 6 of the present invention differs from Embodiment No. 2 in that it comprises a separable electromagnetic-wave transmission subassembly 13 that is made independently of the present front grille 1. The present front grille 1 is provided with a fitting hole 10a at the central portion. The electromagnetic-wave transmission subassembly 13 is fit into the fitting hole 10a. A framed part 10 of the present front grille 1 is made from the same acrylic resin as that makes a transparent substrate 2 of the electromagnetic-wave transmission subassembly 13. The electromagnetic-wave transmission subassembly 13 is made up of the transparent substrate 2, a decorative layer 3, a resinous adhesion layer 5 and a base substrate 6 in this order from the front side to the rear side. These constituent elements are the same as those of the electromagnetic-wave transmission subassembly 12 according to Embodiment No. 2. The present electromagnetic-wave transmission subassembly 13 according to Embodiment No. 6 is fastened onto an installation seat 10c, which protrudes rearward from the rim of the fitting hole 10a in the front grille 1, by a protuberant tab 6c, which protrudes from the rear-face periphery of the base substrate 6. Other than the constituent elements being described herein, the present front grille 1 according to Embodiment No. 6 comprises the same constituent elements as those of Embodiment No. 2.

The present front grille 1 according to Embodiment No. 6 also comprises the resinous adhesion layer 5 that is made from a hot-melt adhesive exhibiting high heat resistance and pressure resistance, and which bonds the base substrate 6 onto the transparent substrate 2. Hence, the resinous adhesion layer 5 can likewise keep the decorative layer 3 and transparent substrate 2 from being thermally damaged at the time of making the base substrate 6.

### Embodiment No. 7

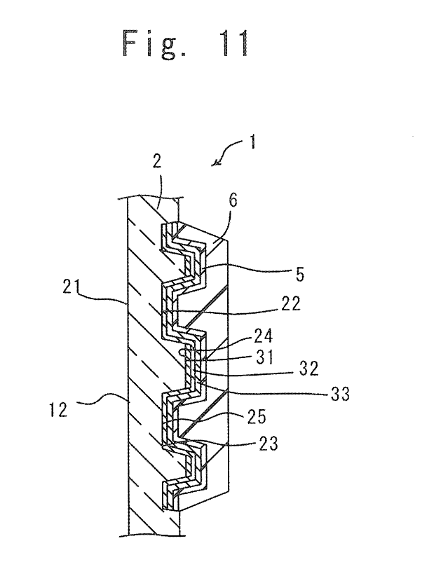

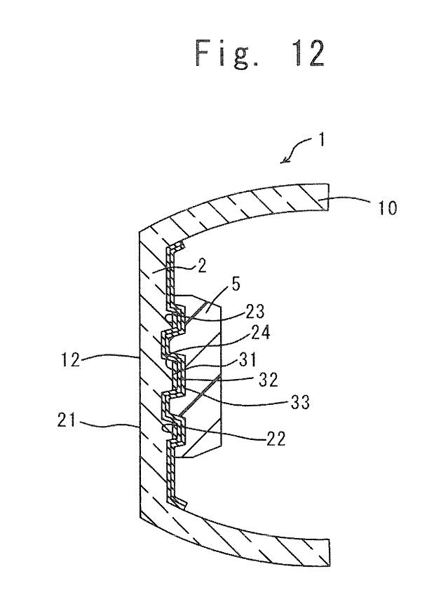

As illustrated in FIGS. 10 and 11, a front grille 1 according to Embodiment No. 7 of the present invention is distinct from Embodiment No. 6 in that it comprises the transparent substrate 2 that is provided with three decorative layers (31, 32, 33) on the rear face 22. The first decorative layer 31 is formed on the protuberant sections 24 in the irregularity 23 of the transparent substrate 2. The first decorative layer 31 is formed by screen printing, and is made from a black paint. The second decorative layer 32 is formed entirely on the irregularity 23 that is provided with the first decorative layer 31. The second decorative layer 32 comprises a vapor-deposited film that is made by vapor depositing indium. Note herein that electromagnetic waves can transmit a thin vapor-deposited film that is made from indium. The third decorative layer 33 is made from a masking paint.

The third decorative layer 33 is provided with a base substrate 6 on the rear face byway of a resinous adhesion layer 5. The base substrate 6 is formed on the rear face of the resinous adhesion layer 5 by insert molding.

When a user views the first and second decorative layers (31, 32) from one of the opposite sides on the front face 21 of the transparent substrate 2, he or she sees the second decorative layer 32 inside the recessed sections 25 in the irregularity 23 of the transparent substrate 2 that take on a shape of letter. Moreover, the user sees the black paint making the first decorative layer 31, which serves as the background color to the letter, on the protuberant sections 24 in the irregularity 23 of the transparent substrate 2.

The present front grille 1 according to Embodiment No. 7 comprises the first, second and third decorative layers (31, 32, 33) that intervene between the transparent substrate and the resinous adhesion layer 5 over the entire electromagnetic-wave transmission subassembly 12 virtually. Because of this, the millimeter electromagnetic wave might possibly attenuate or damp slightly when it transmits through the first, second and third decorative layers (31, 32, 33). However, since the relative dielectric constant of the resinous adhesion layer S and that of the base substrate 6 agree with each other substantially, the millimeter electromagnetic wave hardly attenuates or damps at the interface between the resinous adhesion layer 5 and the base substrate 6.

Besides, the resinous adhesion layer 5 is made from a hot-melt adhesive that melts at a relatively low temperature to exhibit a low viscosity. Therefore, the hot-melt adhesive little gives thermal damages to the first, second and third decorative layers (31, 32, 33) as well as the transparent substrate 2 when it bonds the base substrate 6 onto the rear face 22 of the transparent substrate 2.

### Embodiment No. 8

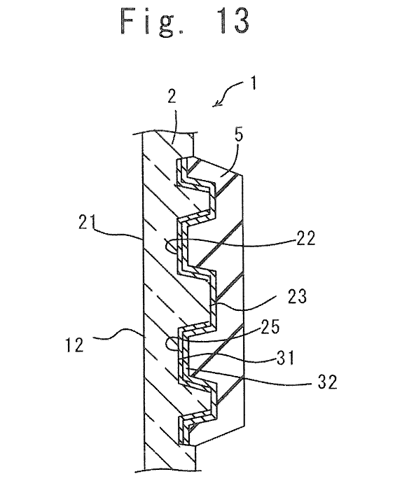

As illustrated in FIG. 12, a front grille 1 according to Embodiment No. 8 of the present invention comprises a first decorative layer 31 with which a transparent substrate 2 is provided on the protuberant sections 24 in the irregularity 23 in the rear face 22. Moreover, the first decorative layer 31 is provided with a second decorative layer 32 on the rear face, and the second layer 32 is in turn provided with a third decorative layer 33 on the entire rear surface. In addition, the third decorative layer 33 is covered with a resinous adhesion layer 5 on the rear face partially.

The first decorative layer 31 is shaped into a letter that gives a metallic color, and is formed by means of transferring a foil by hot stamping, or by means of printing. The second decorative layer 32 makes a black-colored background, and is formed by means of vapor deposition or sputtering. The third decorative layer 32 is made from a masking paint, and is formed on the entire rear surface of the second decorative layer 32. Specifically, the masking paint can be a ultraviolet (or UV) coating, for instance. The second and third decorative layers (32, 33) are formed not only onto the electromagnetic-wave transmission subassembly 12 but also up and down onto a framed part 10 that is present around the electromagnetic-wave transmission subassembly 12. Since the first, second and third decorative layers (31, 32, 33) exhibit such a thin summed thickness as from 0.1 to 0.2 mm, and since they are also formed from materials that are less likely to shield electromagnetic waves, they can transmit electromagnetic waves.

Except for the first, second and third decorative layers (31, 32, 33), the present front grille 1 according to Embodiment No. 8 comprises the same constituent elements as those of Embodiment No. 1. Not that the present front grille 1 comprises the third decorative layer 33 that is made from a masking paint. Accordingly, a user cannot at all view the resinous adhesion layer 5 from one of the opposite sides of the present front grille 1 on the front face. Consequently, it is possible for manufacturers of the present front grille 1 to diversify types of the material that is employable for making the resinous adhesion layer 5.

### Embodiment No. 9

As illustrated in FIG. 13, a front grille 1 according to Embodiment No. 9 of the present invention comprises a first decorative layer 31, and a second decorative layer 32. The first decorative layer 31 is formed on recessed sections 25 in an irregularity 23 of a transparent substrate 2. Moreover, the second decorative layer 32 is formed on a rear face of the first decorative layer 31. In addition, the second decorative layer 32 is covered with a resinous adhesion layer 5 on the rear face entirely.

The first decorative layer 31 is formed on recessed sections 25 in the irregularity 23 of the transparent substrate 2, and is shaped into a metallic-colored letter. The first decorative layer 31 is formed by means of transferring a foil by hot stamping, or by means of printing. The second decorative layer 32 is made from a masking paint, and is formed on a rear face 22 of the transparent substrate 2 within the resulting electromagnetic-wave transmission subassembly 12. The resinous adhesion layer 5 contains a black pigment to show a black color. Consequently, the present front grille 1 according to Embodiment No. 9 does not at all require the black-colored layer, namely, the third decorative layer 33 that the present front grille 1 according to Embodiment No. 8 requires. Note that, other than the above-described first and second decorative layers (31, 32), the present front grille 1 comprises the same constituent elements as those of Embodiment No. 1.

### Embodiment No. 10

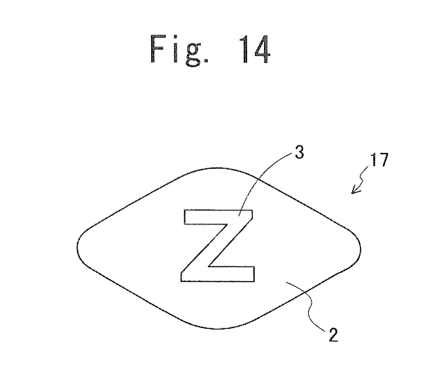

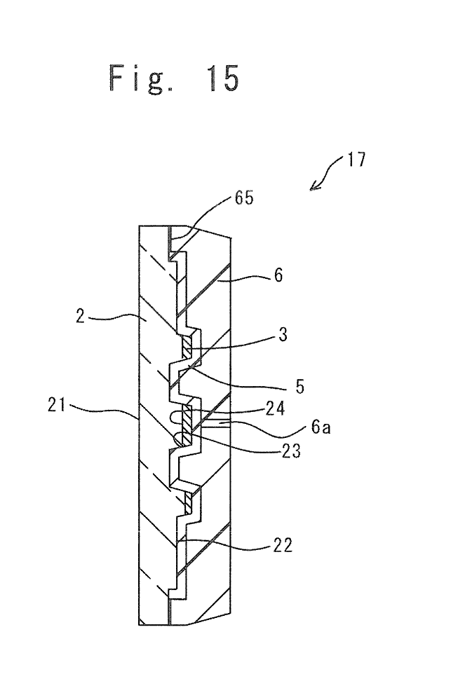

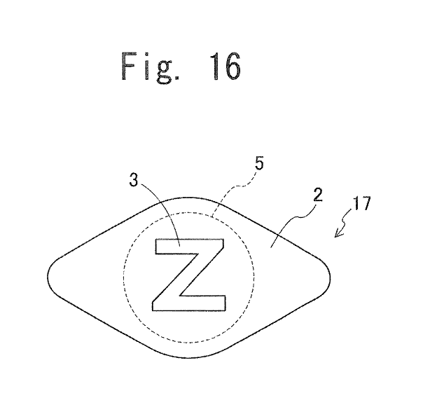

As illustrated in FIGS. 14 and 15, a decorative member for vehicle according to Embodiment No. 10 of the present invention makes an emblem 17 to be installed onto a vehicular body. The emblem 17 is formed as a squared shape that is extended slightly in the right/left direction. The emblem 17 is provided with a decorative layer 3, which is shaped into a letter that is applied onto a central section of the emblem 17. The emblem 17 comprises a transparent substrate that is made from a transparent acrylic resin, or a polycarbonate (or PC) resin. A rear face 22 of the transparent substrate 2 is provided with an irregularity 23 at the central section, as shown in FIG. 15. Moreover, protuberant sections 24 in the irregularity 23 of the transparent substrate 2 are provided with a decorative layer 3. In addition, the decorative layer 3 is made from a metallic foil that comprises chromium.

The present emblem 17 according to Embodiment No. 10 comprises a resinous adhesion layer 5 that covers the rear face 22 of the transparent substrate 2 entirely. The resinous adhesion layer 5 is made from a hot-melt adhesive that comprises at least one member being selected from the group consisting of polyamide, polyurethane and polyester. Moreover, the present emblem 17 according to Embodiment No. 10 further comprises a base substrate 6 that is bonded onto the entire rear face 22 of the transparent substrate 2 by way of the resinous adhesion layer 5. In addition, the base substrate 6 is made from an AES copolymer, and is a separate constituent element that is formed independently of the transparent substrate 2.

In order to manufacture the present emblem 17 according to Embodiment No. 10, the transparent substrate 2 is made by injection molding using a mold. First, the decorative layer 3 is formed onto the protuberant sections 24 in the irregularity 23 in the rear face 22 of the transparent substrate 2 by thermally transferring a chromium foil with use of a hot-stamping machine. Second, the base substrate 6 is made by injection molding using another mold. Third, the transparent substrate 2 and base substrate 2 are brought closer to each other, and then a molten hot-melt adhesive is injected between the two through an injection inlet 6a with which the base substrate 6 is provided. Fourth, the molten hot-melt adhesive, which has filled up between the transparent substrate 2 and the base substrate 6, is cooled to cure between the two, so that the resinous adhesion layer is formed. Finally, the base substrate 6, and the transparent substrate 2 are welded one another by a laser at their outer-circumference rims between the two.

The present emblem 17 according to Embodiment No. 10 comprises the decorative layer 3 being covered with the resinous adhesion layer 5 that is made from a hot-melt adhesive. The hot-melt adhesive, which is supplied onto the rear face 22 of the transparent substrate 2, is put under the condition that it is melt to turn into a low-viscosity substance. Consequently, it is possible to form the resinous adhesion layer 5 at a relatively low pressure. In addition, the hot-melt adhesive is less likely to give damages and deformations to the decorative layer 3 and transparent substrate 2, because it melts at a relatively low temperature. Therefore, the hot-melt adhesive making the resinous adhesion layer 5 does not at all impair the looks of the decorative layer 3 at the time of manufacturing the present emblem 17.

Moreover, since the decorative layer 3 is formed on the protuberant sections 24 in the irregularity 23 in the rear face 22 of the transparent substrate 2, the decorative layer 3 appears three-dimensionally on an inner or back side to the transparent substrate 2 when the present emblem 17 according to Embodiment No. 10 is viewed from one of the opposite sides on the front face 21 of the transparent substrate 2. Thus, the present emblem 17 is higher in terms of the decorativeness.

### Embodiment No. 11

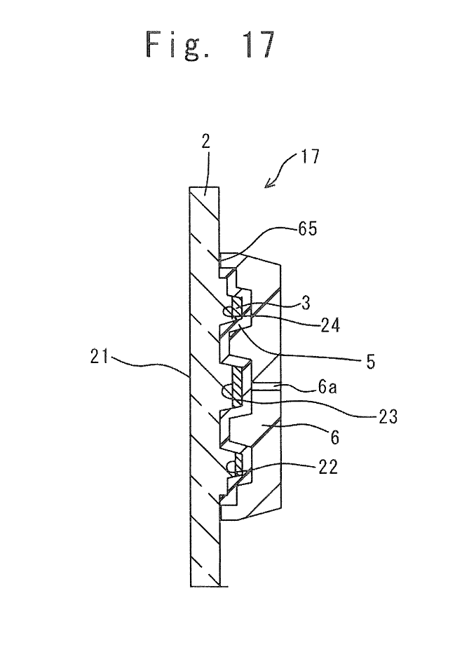

As illustrated in FIGS. 16 and 17, an emblem 17 according to Embodiment No. 11 of the present invention comprises a base substrate 6, and a resinous adhesion layer 5 that bonds the base substrate 6 only onto parts of an irregularity 23 with which a rear face 22 of a transparent substrate 2 is provided. Moreover, protuberant sections 24 in the irregularity 23 are provided with a decorative layer 3. In addition, the transparent substrate 2, on which the decorative layer 3 is formed, is covered with the base substrate 6 by way of the resinous adhesion layer 5 on the side of the rear face 22. Other than these particular features of the base substrate 6, resinous adhesion layer 5, decorative layer 3 and transparent substrate 2, the present emblem 17 comprises the same constituent elements as those of the present emblem 17 according to Embodiment No. 10.

Since the present emblem 17 according to Embodiment No. 11 comprises the base substrate 6 that is smaller than the transparent substrate 2, it is possible to make a mold, which is used to mold the base substrate 6, smaller.

### Embodiment No. 12

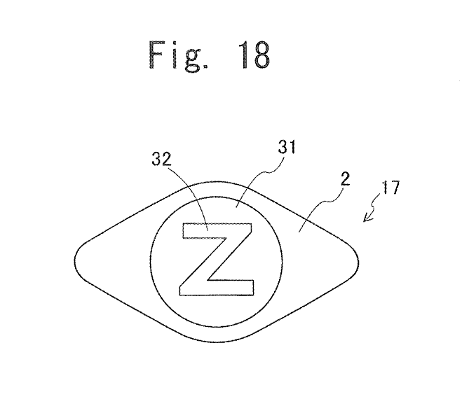

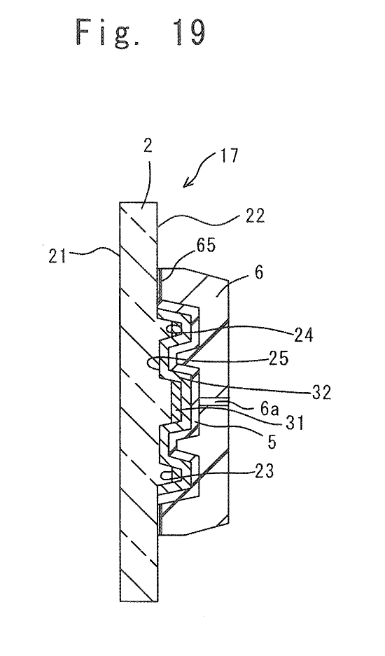

As illustrated in FIGS. 18 and 19, an emblem 17 according to Embodiment No. 12 of the present invention is distinguished from the present emblem 17 according to Embodiment No. 11 in that it comprises two decorative layers (31, 32) that are formed on a rear face 22 of a transparent substrate 2. The rear face 22 of the transparent substrate 2 is provided with an irregularity 23 whose recessed sections 25 are formed as a configuration that shapes a letter. The first decorative layer 31 is made from a black pigment, and is formed by screen printing onto protuberant sections 24 in the irregularity 23 of the transparent substrate 2. The second decorative layer 32 comprises a vapor-deposited film that is made by vapor depositing indium. Note that the second decorative layer 32 is formed entirely on the irregularity 23.

When a user views the first and second decorative layers (31, 32) from one of the opposite sides of the present emblem 17 according to Embodiment No. 12 on the side of the front face 21 of the transparent substrate 2, he or she sees the second decorative layer 32 inside the recessed sections 25 of the irregularity 23 that take on a lettered shape. Moreover, on the protuberant sections 24 of the irregularity 23, the user sees the first decorative layer 31 made from a black paint that serves as a background to the lettered shape.

The present emblem 17 according to Embodiment No. 12 comprises the resinous adhesion layer 5 being made from a hot-melt adhesive that melts at a relatively low temperature to turn into a molten substance with a low viscosity. Therefore, the hot-melt adhesive does not at all give thermal damages to the first and second decorative layers (31, 32) as well as to the transparent substrate 2 when it bonds the base substrate 6 onto the rear face 22 of the transparent substrate 2.

Having now fully described the present invention, it will be apparent to one of ordinary skill in the art that many changes and modifications can be made thereto without departing from the spirit or scope of the present invention as set forth herein including the appended claims.

What is claimed is:

1. A decorative member for vehicle, the decorative member comprising:
a transparent substrate having a front face and a rear face, and comprising a transparent material;
a decorative layer being formed on the rear face of the transparent substrate, and being visible through the transparent substrate when the decorative member is viewed on the front face of the transparent substrate; and
a resinous adhesion layer covering the rear face of the transparent substrate on which the decorative layer is formed, and comprising a hot-melt adhesive.

2. The decorative member according to claim 1, wherein:
the transparent substrate, the decorative layer and the resinous adhesion layer makes an electromagnetic-wave transmission subassembly being disposed in front of a millimeter-electromagnetic-wave radar; and
the transparent substrate, the decorative layer and the resinous adhesion layer have a thickness, respectively, and a summed thickness of the thicknesses of the transparent substrate, decorative layer and resinous adhesion layer exhibits a predetermined thickness uniformly in the electromagnetic-wave transmission subassembly.

3. The decorative member according to claim 2, wherein the electromagnetic-wave transmission subassembly comprises:
the transparent substrate exhibiting a relative dielectric constant;
the resinous adhesion layer exhibiting another relative dielectric constant; and
the relative dielectric constant of the transparent substrate approximating the relative dielectric constant of the resinous adhesion layer within a range of ±0.2.

4. The decorative member according to claim 3, wherein the decorative layer, and the resinous adhesion layer are formed partially on the rear face of the transparent substrate.

5. The decorative member according to claim 4, wherein:
the rear face of the transparent substrate is provided with an irregularity; and
the decorative layer is formed on the irregularity.

6. The decorative member according to claim 5 further comprising a base substrate covering a rear face of the resinous adhesive layer.

7. The decorative member according to claim 6, wherein the hot-melt adhesive comprises at least one member that is selected from the group consisting of polyamides, polyurethanes, and polyesters.

8. The decorative member according to claim 1, wherein the decorative layer, and the resinous adhesion layer are formed partially on the rear face of the transparent substrate.

9. The decorative member according to claim 8, wherein:
the rear face of the transparent substrate is provided with an irregularity; and
the decorative layer is formed on the irregularity.

10. The decorative member according to claim 9 further comprising a base substrate covering a rear face of the resinous adhesive layer.

11. The decorative member according to claim 10, wherein the hot-melt adhesive comprises at least one member that is selected from the group consisting of polyamides, polyurethanes, and polyesters.

12. The decorative member according to claim 1, wherein:
the rear face of the transparent substrate is provided with an irregularity; and
the decorative layer is formed on the irregularity.

13. The decorative member according to claim 12 further comprising a base substrate covering a rear face of the resinous adhesive layer.

14. The decorative member according to claim 13, wherein the hot-melt adhesive comprises at least one member that is selected from the group consisting of polyamides, polyurethanes, and polyesters.

15. The decorative member according to claim 1 further comprising a base substrate covering a rear face of the resinous adhesive layer.

16. The decorative member according to claim 15, wherein the hot-melt adhesive comprises at least one member that is selected from the group consisting of polyamides, polyurethanes, and polyesters.

17. The decorative member according to claim 1, wherein the hot-melt adhesive comprises at least one member that is selected from the group consisting of polyamides, polyurethanes, and polyesters.

18. The decorative member according to claim 1 further comprising a millimeter-electromagnetic-wave radar being disposed on a rear face of the resinous adhesion layer.

19. The decorative member according to claim 18 further comprising a base substrate being disposed to intervene between the rear face of the resinous adhesion layer and a front face of the millimeter-electromagnetic-wave radar.

20. The decorative member according to claim 19, wherein the resinous adhesion layer and the base substrate are bonded seamlessly to each other electromagnetically.
